(19) United States
(12) Patent Application Publication
(10) Pub. No.: US 2026/0362155 A1
(43) Pub. Date: Nov. 12, 2026

(54) APPARATUS FOR VISUALIZE RADIO WAVE CONDITION, METHOD THEREOF, AND PROGRAM

(71) Applicant: NTT, Inc., Tokyo (JP)

(72) Inventors: Masashi KOBAYASHI, Tokyo (JP); Kazuaki AKASHI, Tokyo (JP)

(73) Assignee: NTT, Inc., Tokyo (JP)

(21) Appl. No.: 19/477,147

(22) PCT Filed: Apr. 25, 2023
(86) PCT No.: PCT/JP2023/016314

§ 371 Date: Oct. 21, 2025

(51) Int. Cl. H04W 16/18; H04W 24/08

(52) U.S. Cl. CPC H04W 16/18; H04W 24/08

(57) ABSTRACT

A radio wave condition visualization device of the present invention includes a reception unit that receives measurement data indicating a radio wave condition simultaneously measured by a plurality of measurement terminals installed at different measurement points and capable of acquiring the radio wave condition from a common base station with the same performance, an aggregation unit that aggregates the received measurement data in real time, a combining unit that time-synchronously combines the aggregated measurement data, and a display control unit that visualizes and displays the combined measurement data on an area map indicating an installation place of the base station in real time.

### TECHNICAL FIELD

The present invention relates to a radio wave condition visualization device, a method, and a program for visualizing and displaying a radio wave condition in an area served by a base station.

### BACKGROUND ART

With the recent progress of digitization, connected devices using radio waves such as personal computers, smartphones, and IoT devices have increased in number, and opportunities and numbers of places for utilizing radio waves have increased.

On the other hand, radio waves are invisible and have a characteristic of greatly varying with time.

In addition, communication may be affected by factors such as presence of a shield such as a person or an object and interference caused by simultaneous operation of a plurality of systems (Wi-Fi (registered trademark)/Bluetooth (registered trademark)/microwave oven, or the like) using the same frequency band.

For this reason, at the time of designing/arranging a base station that transmits a radio wave, it is necessary to appropriately design the base station in consideration of radio wave conditions in a use environment, and a technique for ascertaining the radio wave conditions is required.

Currently, in order to ascertain the conditions of wireless radio waves at multiple points, an expert sequentially measures all measurement points with a measurement device.

### CITATION LIST

### Non Patent Literature

Non Patent Literature 1:“Denpa kishika gijutsu ni tsuite (in Japanese) (About radio wave visualization technology)”, written by Teruhisa NINOMIYA https://www.wlan-business.org/wp-content/uploads/2019/12/ffc8b0034eaf8dadela4797acb710b38.pdf (Retrieved on Apr. 4, 2023)

### SUMMARY OF INVENTION

### Technical Problem

However, if the number of measurement points is large, the measurement time becomes long. A longer measurement time results in a time difference between the measurement points. Therefore, equalization of condition differences and combination of information require a corresponding time and expert skills.

When the measurement result does not satisfy the design condition, it is necessary to perform re-measurement every time the arrangement of the base station or the orientation of the antenna is changed. Therefore, when trial and error of the actual machine is repeated, there is a problem that it takes a longer time to ascertain the radio wave condition due to a long measurement time.

The present invention has been made in view of such circumstances, and an object thereof is to provide a radio wave condition visualization device, a method, and a program capable of reducing the time required to ascertain the radio wave condition without requiring the skill and knowledge of an expert.

### Solution to Problem

In order to achieve the above object, a radio wave condition visualization device according to a first aspect of the present invention includes a reception unit that receives measurement data indicating radio wave conditions simultaneously measured by a plurality of measurement terminals installed at different measurement points and capable of acquiring the radio wave condition from a common base station with the same performance, an aggregation unit that aggregates the received measurement data in real time, a combining unit that time-synchronously combines the aggregated measurement data, and a display control unit that visualizes and displays the combined measurement data on an area map indicating an installation place of the base station in real time.

### Advantageous Effects of Invention

According to the radio wave condition visualization device, the method, and the program of the present invention, it is possible to shorten the time required to ascertain the radio wave condition without requiring the skill and knowledge of an expert.

### BRIEF DESCRIPTION OF DRAWINGS

FIG. 1 is a diagram illustrating a visualization display example (in a case where a radio wave environment is not appropriate) of a radio wave condition visualization device according to the present embodiment.

FIG. 2 is a simplified block diagram illustrating a relationship between a radio wave condition visualization device and a measurement terminal according to the present embodiment.

FIG. 3 is a configuration diagram illustrating an electronic configuration example of the radio wave condition visualization device according to the present embodiment.

FIG. 4 is a flowchart illustrating an operation example of the radio wave condition visualization device according to the present embodiment.

FIG. 5 is a diagram illustrating a visualization display example (in a case where the radio wave environment is appropriate) by the radio wave condition visualization device according to the present embodiment.

### DESCRIPTION OF EMBODIMENTS

Hereinafter, each embodiment of the present invention will be described with reference to the drawings. The drawings are schematic or conceptual, and a relationship between a thickness and a width of each portion, a ratio of sizes between portions, and the like, are not necessarily the same as actual ones. In addition, even in the case of representing the same portion, dimensions and ratios may be represented differently from each other depending on the drawings. In the specification of the present application and each drawing, the same reference numerals are given to the same elements as those described above with respect to the previously described drawings, and detailed description and redundant description are appropriately omitted.

A radio wave condition visualization device to which a radio wave condition visualization method according to an embodiment of the present invention is applied will be described.

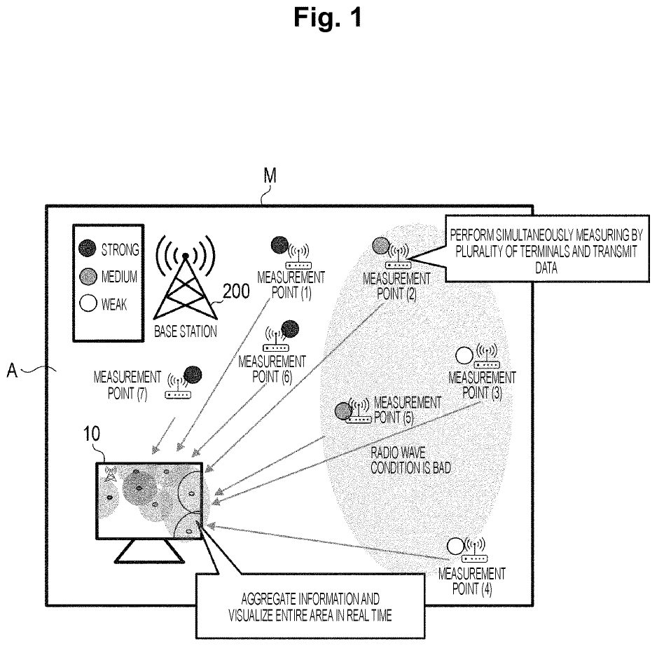

FIG. 1 is a diagram illustrating a visualization display example (in a case where a radio wave environment is not appropriate) of a radio wave condition visualization device according to the present embodiment.

A radio wave condition visualization device 10 is a device that visualizes and displays radio wave conditions at a plurality of measurement points (FIG. 1 illustrates 7 measurement points 1 to 7 as an example) distributed in an area A served by one base station 200 on an area map M.

Although FIG. 1 illustrates only 7 measurement points 1 to 7 as an example, the number of measurement points in the area A is not limited to 7, and may be 2 or more and 6 or less, or 8 or more.

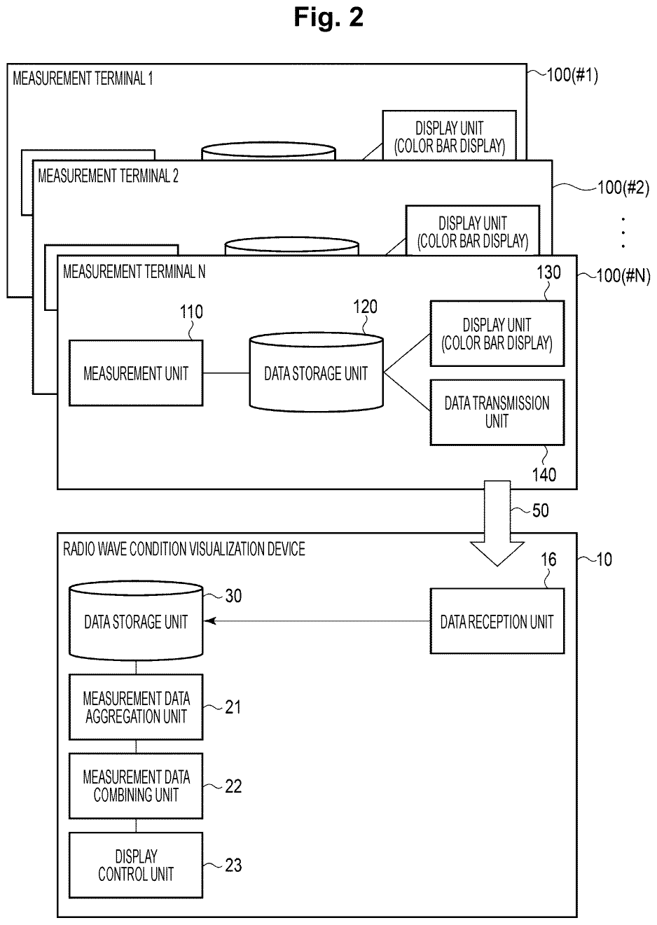

FIG. 2 is a simplified block diagram illustrating a relationship between a radio wave condition visualization device and a measurement terminal according to the present embodiment.

A measurement terminal 100 is disposed at a measurement point, measures a radio wave condition at the measurement point, and transmits measurement data to the radio wave condition visualization device 10. Therefore, the measurement terminal 100 includes a measurement unit 110, a data storage unit 120, a display unit 130, and a data transmission unit 140.

The measurement unit 110 measures a radio wave condition at a measurement point, acquires measurement data, and outputs the acquired measurement data to the data storage unit 120. The radio wave condition at the measurement point corresponds to the radio wave condition from the base station 200 in the area A.

The data storage unit 120 is, for example, a storage device such as a hard disk or an SSD, and stores the measurement data output from the measurement unit 110.

The display unit 130 is, for example, a display, and can display the measurement data stored in the data storage unit 120. The display content is not particularly limited, but can be appropriately displayed using a color bar or the like so that the content of the specific data can be easily ascertained.

The data transmission unit 140 can communicate with the radio wave condition visualization device 10 via a communication network 50 such as the Internet. Using this function, the data transmission unit 140 acquires measurement data from the data storage unit 120, and transmits the measurement data to the radio wave condition visualization device 10.

A plurality of such measurement terminals 100 is used. Therefore, FIG. 2 illustrates N measurement terminals 100(#1 ), 100(#2 ), . . . and 100(#N) (N is any integer greater than or equal to 3). The plurality of measurement terminals 100(#1 ), 100(#2 ), and 100(#N) have the same performance, and can measure the radio wave conditions with the same performance.

For example, the plurality of measurement terminals 100(#1), 100(#2), and 100(#N) are disposed at different measurement points such that the measurement terminal 100(#1 ) is disposed at the measurement point 1, the measurement terminal 100(#2) is disposed at the measurement point 2, and the measurement terminal 100(#3) is disposed at the measurement point 3, and each measurement terminal 100 simultaneously measures the radio wave conditions at the disposed measurement points by each measurement unit 110 to acquire measurement data.

Each measurement terminal 100 outputs the measurement data acquired by the measurement unit 110 to the data storage unit 120, and the data transmission unit 140 acquires the measurement data from the data storage unit 120 and transmits the measurement data to the radio wave condition visualization device 10.

In this manner, measurement data simultaneously measured at each measurement point is transmitted to the radio wave condition visualization device 10 by the plurality of measurement terminals 100 having the same performance.

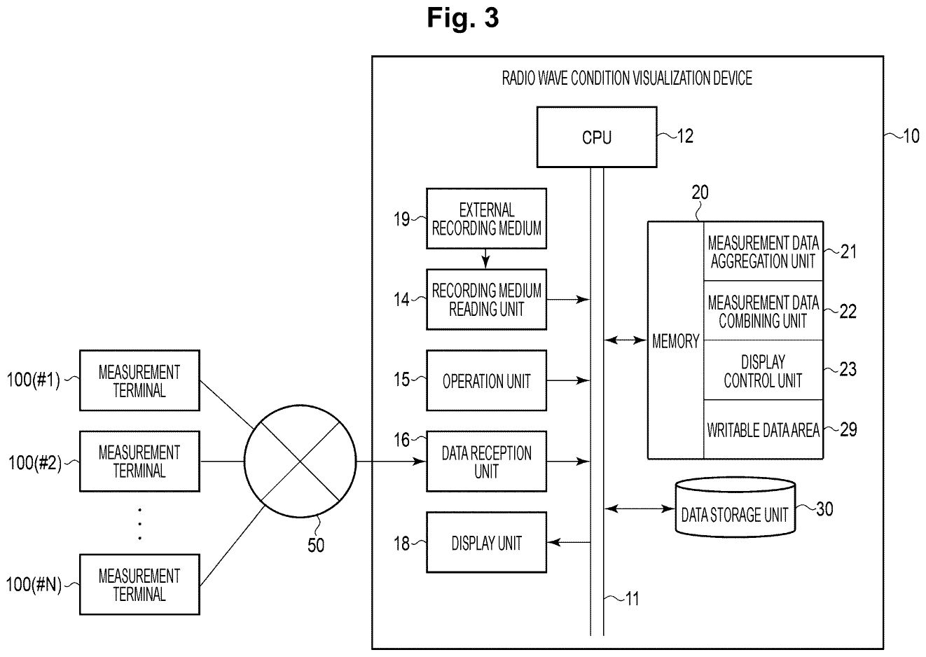

FIG. 2 illustrates a simplified configuration of the radio wave condition visualization device 10. The radio wave condition visualization device 10 includes a data reception unit 16, a data storage unit 30, a measurement data aggregation unit 21, a measurement data combining unit 22, and a display control unit 23, but also includes other components not illustrated in FIG. 2. A detailed configuration of the radio wave condition visualization device 10 including other constituent elements not illustrated in FIG. 2 will be described later with reference to FIG. 3. First, an outline of a configuration of the radio wave condition visualization device 10 will be described below with reference to FIG. 2.

The data reception unit 16 can communicate with each measurement terminal 100 via the communication network 50. Using this function, the data reception unit 16 receives the measurement data transmitted from the data transmission unit 140 of each measurement terminal 100, and outputs the received measurement data to the data storage unit 30.

The data storage unit 30 is, for example, a storage device such as a hard disk or an SSD, and stores the measurement data output from the data reception unit 16.

The measurement data aggregation unit 21 aggregates the measurement data stored in the data storage unit 30 in real time.

The measurement data combining unit 22 combines the measurement data aggregated by the measurement data aggregation unit 21 in time synchronization.

The display control unit 23 creates a screen for visualizing and displaying the measurement data combined by the measurement data combining unit 22 in real time on the area map M indicating the installation place of the base station 200, for example, as illustrated in FIG. 1. An example of the visualization display is to display the base station 200 and the measurement points 1 to 7 on the area map M at places corresponding to the arrangement places in the area A, and further display the measurement points 1 to 7 by color according to the radio wave intensity.

As illustrated in FIG. 1, the display control unit 23 classifies the radio wave intensity at each of the measurement points 1 to 7 into three levels of “strong”, “medium”, and “weak” based on the measurement data coupled by the measurement data combining unit 22, and the measurement points 1, 6, and 7 that are “strong” can be denoted by a green circle, the measurement points 2 and 5 that are “medium” can be denoted by a yellow circle, and the measurement points 3 and 4 that are “weak” can be denoted by a red circle. For example, the display control unit 23 can classify the radio wave intensity lower than the allowable value into “weak”.

Next, the configuration of the radio wave condition visualization device 10 will be described in detail with reference to FIG. 3.

FIG. 3 is a configuration diagram illustrating an electronic configuration example of the radio wave condition visualization device according to the present embodiment.

The electronic configuration of the radio wave condition visualization device 10 includes a CPU 12, a recording medium reading unit 14, an operation unit 15, the above-described data reception unit 16, a display unit 18 such as a display, a memory 20 in which various programs are stored, and the data storage unit 30 connected to each other by a bus 11.

Such a radio wave condition visualization device 10 can be realized by, but not limited to, a PC or a tablet terminal. Alternatively, it is not always necessary to be configured by the same hardware, and functions can be achieved by a plurality of distributed hardware such as a cloud.

The operation unit 15 includes, for example, a mouse, a keyboard, or the like, and the user can operate the operation unit 15 to perform an input necessary for the operation of the radio wave condition visualization device 10.

The memory 20 stores a program for performing measurement data aggregation processing, measurement data combination processing, and display control processing.

That is, the measurement data aggregation unit 21, the measurement data combining unit 22, and the display control unit 23 are realized by programs stored in the memory 20.

The CPU 12 is a computer, and controls operations of the measurement data aggregation unit 21, the measurement data combining unit 22, and the display control unit 23 according to these programs stored in the memory 20.

The program for realizing the measurement data aggregation unit 21, the measurement data combining unit 22, and the display control unit 23 may be stored in the memory 20 in advance, or may be read and stored in the memory 20 from an external recording medium 19 such as a memory card via a recording medium reading unit 14. The program for realizing the measurement data aggregation unit 21, the measurement data combining unit 22, and the display control unit 23 cannot be rewritten.

In addition to such a non-rewritable area, a writable data area 29 is secured in the memory 20 as an area for storing rewritable data.

The display unit 18 can be realized by a display or the like, and displays a screen as illustrated in FIG. 1, for example, created by the display control unit 23.

As described above, in the radio wave condition visualization device 10, hardware such as the bus 11, the CPU 12, the recording medium reading unit 14, the operation unit 15, the data reception unit 16, the display unit 18, the memory 20, and the data storage unit 30, and software which is each program stored in the memory 20 operate in cooperation.

Next, an operation example of the radio wave condition visualization device 10 according to the present embodiment will be described.

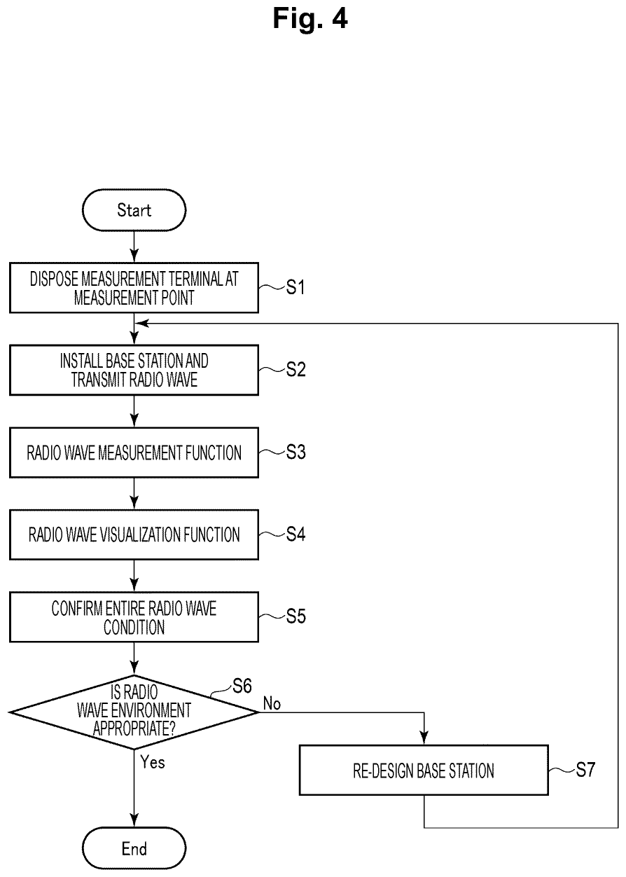

FIG. 4 is a flowchart illustrating an operation example of the radio wave condition visualization device according to the present embodiment.

First, the measurement terminal 100 is disposed at each of a plurality of measurement points distributed in the area A served by one base station 200 (S1).

Hereinafter, as illustrated in FIG. 1, a case where there are seven measurement points 1 to 7 in the area A will be described as an example of the plurality of measurement points. In this case, seven measurement terminals 100 having the same performance are prepared, and each of the measurement terminals 100 is disposed at any one of the measurement points 1 to 7.

Next, the base station 200 is installed in the area A, and transmission of radio waves by the base station 200 is started (S2).

Next, the radio wave conditions are simultaneously measured by the measurement terminal 100 disposed at each of the measurement points 1 to 7 (S3). The radio wave condition at each measurement point corresponds to the radio wave condition from the base station 200. Then, the measurement data is transmitted from the data transmission unit 140 of each measurement terminal 100 to the radio wave condition visualization device 10 via the communication network 50.

Note that, in a case where the number of measurement terminals 100 is smaller than the number of measurement points, the measurement terminal 100 is repeatedly used so that the measurement terminal 100 that has completed the measurement at a certain measurement point is moved to another measurement point and installed at the measurement point to perform the measurement. When the measurement terminal 100 that has finished the measurement at a certain measurement point is moved to another measurement point and installed at the measurement point to perform the measurement, the measurement at at least three measurement points is simultaneously performed. Thereby, at least three pieces of measurement data can be acquired simultaneously.

In the radio wave condition visualization device 10, the measurement data transmitted from the data transmission unit 140 of each measurement terminal 100 is received by the data reception unit 16, output from the data reception unit 16 to the data storage unit 30, and stored by the data storage unit 30.

The measurement data stored in the data storage unit 30 is aggregated in real time by the measurement data aggregation unit 21, and the aggregated measurement data is combined in time synchronization by the measurement data combining unit 22.

Then, based on the measurement data combined by the measurement data combining unit 22, the display control unit 23 creates a screen to be visualized and displayed in real time on the area map M indicating the installation places of the base station 200 and the measurement points 1 to 7. The created screen is displayed from the display unit 18, for example, as illustrated in FIG. 1 (S4).

In the example illustrated in FIG. 1, the radio wave intensity is classified into three stages of “strong”, “medium”, and “weak”. The measurement points 1, 6, and 7 where the radio wave intensity is “strong” are labeled as green circles, the measurement points 2 and 5 where the radio wave intensity is “medium” are labeled as yellow circles, and the measurement points 3 and 4 where the radio wave intensity is “weak” lower than the allowable value are labeled as red circles.

As a result, the state of the radio wave intensity in the area A is visualized, so that the operator can confirm the entire radio wave state in the area A (S5), and can determine whether the radio wave condition in the area A is appropriate (S6).

According to the visualization display as illustrated in FIG. 1, it is clearly indicated that the measurement points 3 and 4 where the radio wave intensity is lower than the allowable value and classified as “weak” and labeled as yellow circles are different from the measurement points 1, 6, and 7 classified as “strong” and labeled as green circles and the measurement points 2 and 5 classified as “medium” and labeled as yellow circles. Such a visualization can prompt the operator to change the installation place of the base station 200.

Therefore, the operator determines that the radio wave environment is not appropriate by viewing the visualized display (S6: No), and redesigns the installation place of the base station 200 (S7). The operator ascertains, from the visualized display as illustrated in FIG. 1, specifically which place in the area A has sufficient radio wave intensity and which place has insufficient radio wave intensity. Therefore, the operator can appropriately redesign the installation place of the base station 200 according to the radio wave intensity situation in the area A.

After the operation in step S7, the processing proceeds to step S2, the base station 200 is installed in the redesigned installation place, and transmission of radio waves by the base station 200 is started (S2).

Thereafter, the operations in steps S3 to S6 as described above are repeated until it is determined in step S6 that the radio wave condition is appropriate (S6: Yes).

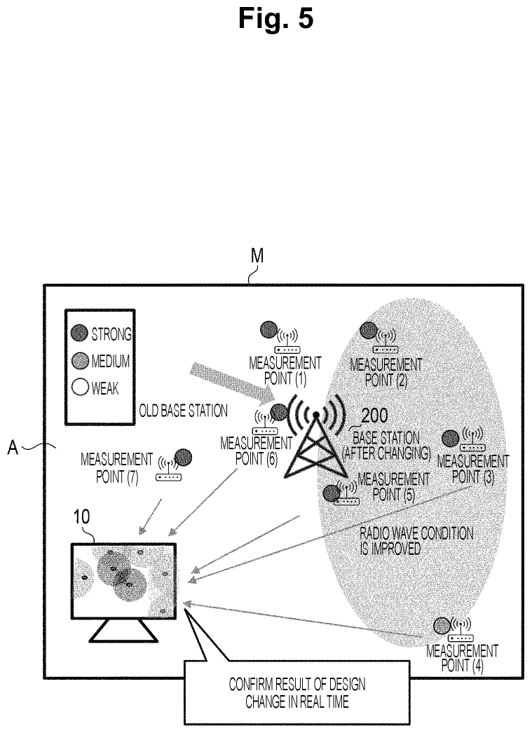

FIG. 5 is a diagram illustrating a visualization display example (in a case where the radio wave environment is appropriate) by the radio wave condition visualization device according to the present embodiment.

FIG. 5 illustrates that, when the base station 200 is moved to the center side of the area A from the state illustrated in the visualized display example in FIG. 1, the radio wave intensities of the measurement points 1 to 3 and 5 to 7 are “strong”, the radio wave intensity of the measurement point 4 is “medium”, and there is no measurement point with the radio wave intensity of “weak”.

As described above, by viewing the visualization display in which there is no measurement point where the radio field intensity is “weak”, the operator can confirm that the base station 200 has been redesigned to an appropriate place and the radio wave environment has been improved.

As described above, according to the radio wave condition visualization device 10 to which the radio wave condition visualization method according to the present embodiment is applied, a plurality of, preferably three or more, measurement terminals 100 capable of acquiring the radio wave conditions with the same performance are used to aggregate measurement data measured simultaneously in real time and combine the measurement data in time synchronization.

As a result, it is possible to measure a plurality of measurement points at the same time under the same condition, and it is possible to simultaneously ascertain the variation of the radio wave with time. Therefore, it is possible to acquire measurement data with a simple device and combine the measurement data without considering the time change and without requiring a high specialized measurement skill.

Furthermore, since the radio wave conditions in the entire area A can be visualized and displayed in real time on the basis of the combined measurement data, the installation place of the base station 200 can be changed while confirming the radio wave conditions, and the time required for redesigning the installation place of the base station 200 can be significantly shortened.

The present invention is not limited to the above embodiments, and various modifications can be made in the implementation stage without departing from the gist thereof. In addition, the above embodiments include various inventions, and various inventions can be extracted by a combination selected from the plurality of disclosed components. For example, in a case where the problems can be solved and the effects can be obtained even if some components are deleted from all the components described in the embodiment, a configuration from which the components are deleted can be extracted as an invention.

### REFERENCE SIGNS LIST

1 to 7 Measurement point
10 Radio wave condition visualization device
11 Bus
12 CPU
14 Recording medium reading unit
15 Operation unit
16 Data reception unit
18 Display unit
19 External recording medium
20 Memory
21 Measurement data aggregation unit
22 Measurement data combining unit
23 Display control unit
29 Writable data area
30 Data storage unit
50 Communication network
100 Measurement terminal
110 Measurement unit
120 Data storage unit
130 Display unit
140 Data transmission unit
200 Base station
A Area
M Area map

1. A radio wave condition visualization device comprising:
a receiver that receives measurement data indicating a radio wave condition simultaneously measured by a plurality of measurement terminals installed at different measurement points and capable of acquiring the radio wave condition from a common base station with the same performance;
aggregation circuitry that aggregates the received measurement data in real time;
combining circuitry that time-synchronously combines the aggregated measurement data; and
display control circuitry that creates a screen for visualizing and displaying the combined measurement data on an area map indicating an installation place of the base station in real time.

2. The radio wave condition visualization device according to claim 1, wherein:
in a case where there is a measurement point at which an intensity of the radio wave is lower than an allowable value, the display control circuitry creates a screen that displays the measurement point at which the intensity of the radio wave is lower than the allowable value on the area map in a specifiable manner in order to prompt a user to change the installation place of the base station.

3. The radio wave condition visualization device according to claim 1, wherein:
the plurality of measurement terminals are three or more measurement terminals.

4. The radio wave condition visualization device according to claim 1, wherein:
the display control circuitry creates a screen that displays the measurement point at which the intensity of the radio wave is lower than the allowable value on the area map in a color different from other measurement points in order to display the measurement point at which the intensity of the radio wave is lower than the allowable value on the area map in a specifiable manner.

5. A radio wave condition visualization method comprising:
arranging three or more measurement terminals capable of acquiring radio wave conditions with the same performance at different measurement points;
installing a base station and transmitting a radio wave from the base station;
receiving, by a device, radio wave condition data simultaneously measured by the measurement terminals;
aggregating, by the device, the received radio wave condition data in real time;
combining, by the device, the aggregated measurement data in a time-synchronized manner; and
visualizing and displaying, by the device in real time, the combined measurement data on an area map indicating an installation place of the base station.

6. The radio wave condition visualization method according to claim 5, wherein:
in a case where there is a measurement point at which the intensity of the radio wave is lower than an allowable value based on the visualization display in the visualizing and displaying, the base station is installed in another place, and the installing, the receiving, the aggregating, the combining, and the visualizing and displaying are repeated until there is no measurement point at which the intensity of the radio wave is lower than the allowable value.

7. A non-transitory computer readable storage medium storing a program for causing a computer to perform the method of claim 5.
